(19) United States
(12) Patent Application Publication
(10) Pub. No.: US 2022/0416530 A1
(43) Pub. Date: Dec. 29, 2022

(54) APPARATUS, METHOD, AND SYSTEM FOR REMOTE CONTROL OF GROUND FAULT CIRCUIT INTERRUPTERS (GFCIS) IN ELECTRICAL SYSTEMS

(71) Applicant: Musco Corporation, Oskaloosa, IA (US)

(72) Inventors: Myron Gordin, Oskaloosa, IA (US); Douglas E. DeVries, Johnston, IA (US); Michael W. Walter, Urbandale, IA (US)

(21) Appl. No.: 17/700,638

(22) Filed: Mar. 22, 2022

Related U.S. Application Data
(60) Provisional application No. 63/213,912, filed on Jun. 23, 2021.

(51) Int. Cl. H02H 3/04; H02H 3/10; G08B 21/18

(52) U.S. Cl. CPC H02H 3/04; H02H 3/105; G08B 21/185

(57) ABSTRACT

Conventional GFCI-type technology typically relies solely on onsite control—for example, pushing a reset button physically located at the impacted circuit to clear a trip and resume operation. For simpler/lower voltage systems—such as outlets in a residence—this is not particularly labor-intensive or confusing. However, for large, complex, and/or high voltage systems—such as sports lighting systems with multiple circuits dozens of feet apart in locked enclosures—trying to perform the same task of pushing a reset button and clearing a trip is much more labor-intensive, and confusing not only in locating the impacted circuit, but in determining what happens next if pushing the reset button does not resume operation. Presented herein are remote control options for GFCIs which could be used in addition to, and not instead of, conventional GFCI-type functionality—or could provide remote-only reset function where a system has no onsite reset button.

This application claims the benefit of U.S. Provisional Application No. 63/213,912, filed Jun. 23, 2021, the entire contents of which are incorporated herein.

### TECHNICAL FIELD

The disclosure generally relates to remote monitoring, trending, reporting, and/or response (hereinafter “remote control”) of ground fault circuit interrupter (GFCI) functionality associated with one or more electrical systems. More specifically, the disclosure relates to supplementing GFCIs at a site with remote control functionality so to provide a host of response options for perceived, actual, or impending overcurrent conditions.

### BACKGROUND

GFCI functionality has existed for lower voltage (e.g., around 150 VAC phase-to-ground) electrical systems for a number of years. More recently, GFCI functionality has been designed and implemented for large, complex, and/or high voltage systems; see, for example, U.S. Pat. No. 8,320,089 incorporated by reference herein. Regardless of whether GFCI functionality exists for a simpler/lower voltage system—such as an outlet in a residence—or a more complicated/high voltage system—such as a sports lighting system—the question exists as to what to do when a trip occurs. In the former example, it may simply be a matter of pressing a reset button at the outlet, or possibly flipping a breaker at some other point or location in the residence; logistics and effort are rarely an issue. This is not true for electrical systems such as in the sports lighting system, as a great deal of effort must be spent to travel to the location, determine which of the many circuits is impacted, locate the precise enclosure which contains a reset button or similar device, access said enclosure (which is likely locked and only available to authorized persons so to prevent tampering), and press or otherwise activate the reset button/similar device. Even then, if pressing the reset button does not restore functionality to the complicated/high voltage electrical system (i.e., clear the trip), it is unclear in many cases what the next step is.

It is clear the reset button or similar device in either above electrical system example is invaluable. This is true not only in allowing onsite control, but also in complying with regulations such as UL-943 and UL-943C, respectively.

### SUMMARY

In general, the disclosure is directed to means and methods of supplementing existing GFCI functionality with remote control functionality so that a variety of options—from more passive options like reporting to more active options like attempting to remotely clear the trip—are available for responding to a trip condition. The disclosure is further directed to the remote control functionality, in addition to, and not instead of, a more conventional response of pressing a reset button on site—though the techniques and systems described herein are equally applicable to remote-only systems and are therefore not restricted to such (e.g., aspects of the disclosure could apply even if there is no onsite reset button).

In the current state of the art of GFCI technology, it is most common for a person to clear a trip by physically pushing a reset button at or near the mechanism which opens the impacted circuit (i.e., the portion of the electrical system which experiences a level of leakage current indicative of a possible safety hazard to persons). However, in large, complex, and/or high voltage electrical systems clearing a trip may not be so easy; there may be several circuits at the site making it difficult to determine the location of the trip, electrical enclosures may be locked thereby preventing access to the reset button, or it may simply be too inconvenient or labor-intensive to travel to the site and clear the trip. There is value in enhancing GFCI-enabled electrical systems—particularly large, complex, and/or high voltage electrical systems such as those in many sports lighting systems—with remote control functionality of the GFCI.

It is therefore a principle object, feature, advantage, or aspect of the example techniques and systems described herein to improve over the state of the art and/or address problems, issues, or deficiencies in the art. The techniques and systems described herein may include means and methods to effectuate offsite and onsite responses to a trip condition from a remote location and means and methods to implement varying degrees of responses depending on whether an overcurrent condition is impeding, actual, or perceived. When compared to GFCI systems without remote functionality, the remote GFCI functionality described herein may facilitate troubleshooting and/or repair of a tripped circuit (and/or of an underlying overcurrent condition), provide an onsite visual indication of a trip which enables persons to more readily locate the impacted circuit, and reduce time and effort spent to clear a trip through one or more automated processes.

In one example, the disclosure is directed to a method of remotely resetting a GFCI in an electrical system. The method includes, upon detection of a predetermined leakage current, activating the GFCI. The method further includes communicating a signal indicating activation of the GFCI to a remote control center. The method also includes, according to one or more predetermined factors, performing one or more of the following: a remote manual action, a remote automated action, a local automated action, and a local manual action.

In another example, the disclosure is directed to a system for remote monitoring, trending, reporting, and/or response of an overcurrent condition. The system includes an electrical system. The system further includes a GFCI associated with the electrical system adapted to terminate power to at least a portion of the electrical system in response to the overcurrent condition. The system also includes a remote control center. The system further includes a control module associated with the electrical system adapted to communicate one or more power commands from the remote control center to the electrical system, and further adapted to communicate one or more feedback signals to the remote control center. The system also includes a display associated with the remote control center which displays one or more of said feedback signals, availability of service persons, and options for responses to the overcurrent condition.

In another example, the disclosure is directed to a device for remotely resetting a GFCI in an electrical system. The device includes one or more communication units configured to receive, from the electrical system, a signal indicating activation of the GFCI. The device further includes one or more processors configured to, in response to receiving the signal including the activation of the GFCI, generate a response signal including instructions for performing one or more of a remote manual action, a remote automated action, a local automated action, and a local manual action. The one or more communication units are further configured to send the response signal to the electrical system.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the disclosure. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1A illustrates a large, complex, and/or high voltage system which includes GFCI functionality and remote power control—here, a sports lighting system—which may benefit from at least some aspects of the present disclosure.

FIG. 1B illustrates a partial block diagram of at least some of the components of the sports lighting system of FIG. 1A; note that for clarity, only one load and one complete circuit (at Pole A) is illustrated.

FIG. 2 illustrates one possible method, according to aspects of the present disclosure, of effectuating remote (i.e., offsite) and/or local (i.e., onsite) action in response to a trip in the sports lighting system of FIG. 1A.

FIG. 3 illustrates one possible sub-method, according to aspects of the present disclosure, to determine which of possible actions 2006A-D of FIG. 2 are effectuated based on possible factors (persons-defined or otherwise).

FIG. 4 illustrates a visual alarm system which may be used to provide an onsite visual indication of a trip according to at least some aspects of the present disclosure.

FIG. 5 illustrates an example computing device associated with the remote control center according to at least some aspects of the present disclosure.

### DETAILED DESCRIPTION

The following detailed description is exemplary in nature and is not intended to limit the scope, applicability, or configuration of the invention in any way. Rather, the following description provides some practical illustrations for implementing examples of the present disclosure. Those skilled in the art will recognize that many of the noted examples have a variety of suitable alternatives.

To further an understanding of the techniques and systems described herein, examples according to the present disclosure will be described in detail. Frequent mention will be made in this description to the drawings. Reference numbers will be used to indicate certain parts in the drawings. Unless otherwise stated, the same reference numbers will be used to indicate the same parts throughout the drawings.

Regarding terminology, the terms “GFCI”, “GFCI-type functionality”, and “GFCI technology” are used interchangeably herein; this is by way of convenience, and to encompass all means and methods which provide interruption of power in an electrical system when leakage current indicates a possible safety hazard to persons. The use of one term over another does not impart any limitations unless explicitly stated herein. Also, the term “persons” is used generically herein; this term could encompass—in the singular or plural—those who may operate GFCIs (or electrical systems including GFCIs), define operating conditions of GFCIs, and the like, and in the case of benefitting from GFCIs or being impacted if GFCIs are not present or functional, should be broadened to encompass not only humans, but livestock and other living creatures. The use of this term does not impart any limitations on who may practice or benefit from aspects of the present disclosure unless explicitly stated herein. With regards to “push” and “button”—both are generic terms used by way of convenience to reference the action of attempting to clear a trip and reset a circuit, yet neither term is restricted to the physical act of pushing, nor to the physical form of a button.

Further regarding terminology, as has been stated “remote control” as used herein may relate to monitoring, trending, reporting, response, or some combination thereof with respect to GFCI-type functionality of an electrical system—this is distinct and different from “remote power control” which is a term used herein to describe the remote control of power in response to a planned event (e.g., an on/off schedule) rather than an overcurrent condition (impending, actual, or perceived). As an example, remote control of GFCI functionality may include monitoring leakage current over time and reporting out when a perceived, actual, or impending overcurrent condition occurs (or when trends in monitored data indicate such might occur) whereas remote power control may include powering the electrical system upon request from an authorized user (perhaps with reporting on total number of hours spent powered); in such an example, even if an authorized user requested the electrical system be powered (e.g., that lights be “on”), such a request would be overridden by the GFCI functionality if a leakage current exceeding the GFCI threshold was detected (e.g., because the GFCI has activated and it is not possible to electrically power the circuit for normal operation without first clearing the trip (i.e., resetting the GFCI)). In essence, even though remote control of power and remote control of GFCI may originate from the same location or result in reporting to the same persons (which is later discussed), they are separate functions and distinct terms as used herein.

Further regarding the term “remote control”, remote control of GFCI-type functionality may include providing a visual indication of a perceived, actual, or impending overcurrent condition on site at or near the electrical system so to allow persons to more readily find the location of the trip. In essence, “remote control” is intended to mean some analysis or action taken remotely as a part of intended GFCI-type functionality, but does not preclude also effectuating control on site. Finally, it should be noted the examples of the techniques and systems described herein envision means and methods of supplementing or otherwise enhancing existing GFCI-type functionality in electrical systems with remote control rather than replacing it—this is because not only is there an inherent benefit to having onsite control of GFCI-type functionality, but often it is a requirement (see, e.g., UL-943 and UL-943C). Therefore, as used herein the term “remote control” of GFCI refers to any of the aforementioned, as well as more specific examples later given, with respect to an electrical system enabled with GFCI-type functionality (which would include onsite control (e.g., a reset button)).

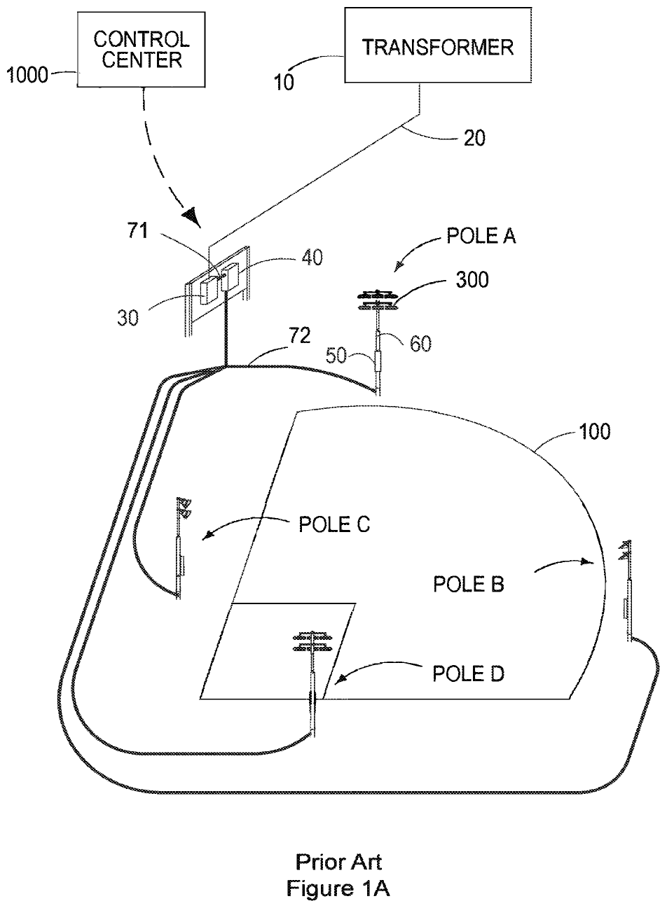

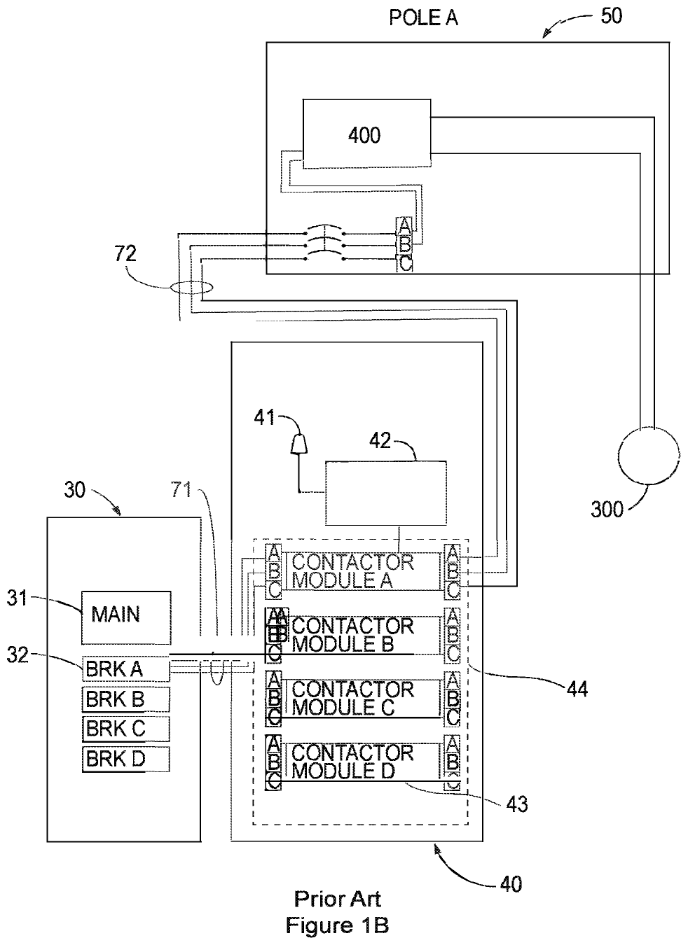

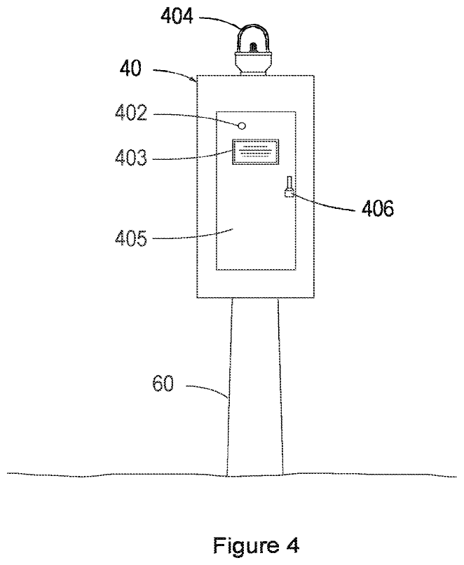

By way of introduction and not by way of limitation, consider a large, complex, and/or high voltage electrical system already enabled with GFCI-type functionality such as is described in aforementioned U.S. Pat. No. 8,320,089; here, represented in simplified form in Figures TA and B. In general, a transformer 10 from a utility company or other energy provider provides electrical power to a service distribution enclosure 30 via distribution wiring 20. Service distribution enclosure 30 typically includes, among other things, a main power breaker 31 (activation of which terminates power to all fixtures 300 and electrical devices at field 100), as well as one or more breakers 32 each of which is associated with one or more control enclosures 40. Power lines 71—which are illustrated as three-phase for the system of FIGS. 1A and B but could be single phase—run from each respective breaker 32 in enclosure 30 to a corresponding contactor module 43 in enclosure 40. For high voltage systems, contactor modules 43—which are high voltage components—are often shielded and isolated behind a touch-safe surface 44—which could be locked—to protect more sensitive components, as well as persons accessing enclosure 40. Reset buttons (not shown in FIG. 1B) common with conventional GFCIs would project out of the face of surface 44 so to be readily accessible much like reset buttons project out of the face of outlet covers in residences where outlets are enabled with GFCIs. However, it is important to note that enclosure 40 itself (and likely enclosures 30 and 50) are also locked—see FIG. 4—so to deter tampering, theft, and unnecessary risk to persons.

From each contactor module 43, power lines 72 (again, three-phase for the system in FIGS. 1A and B, though this could differ in other examples contemplated under the techniques and systems of this disclosure) run some length (often in underground conduit, not illustrated) to each location containing a load; here, a load comprises one or more LED lighting fixtures 300 elevated on poles 60, though this could differ in practice. For the electrical system illustrated in FIGS. 1A and B, power from lines 72 is conditioned for the specific load 300 at an electrical components enclosure 50 which houses, among other things, one or more drivers 400. This is a simplified description of how power is delivered from beginning to end in a complex electrical system, but is suitable for purposes relating to the techniques and systems described herein.

The aforementioned power delivery could be effectuated entirely on site (e.g., with a series of breakers and on/off buttons), but this is unlikely in practice because of the labor-intensive nature of perpetually returning to a sports field to turn lights on and off, though still possible. More often than not, remote control of power is effectuated from a remotely located control center 1000 which communicates power control commands to a control module 42 located in each control enclosure 40; here, commands are communicated at least partially wirelessly via two-way antenna 41 to control module 42, and at the appropriate times, to contactor modules 43. Means and methods for providing remote power control to an electrical system such as that illustrated in FIGS. 1A and B may be as described in U.S. Pat. No. 6,681,110, incorporated by reference herein in its entirety, or otherwise.

Additionally, a large, complex, and/or high voltage electrical system already enabled with GFCI-type functionality such as is described in aforementioned U.S. Pat. No. 8,320,089 is likely designed in accordance with UL-943C, which in turn (in its current revision), requires reliable equipment grounding and monitoring of said equipment grounding with the ability to interrupt the circuit if continuity is lost (or, alternatively, a double insulation). Such ground monitoring could be provided as is described in U.S. Pat. No. 8,537,516 incorporated by reference herein in its entirety.

All of the aforementioned, including other generalized examples described in the various incorporations, form the background for an example of the techniques and systems described herein.

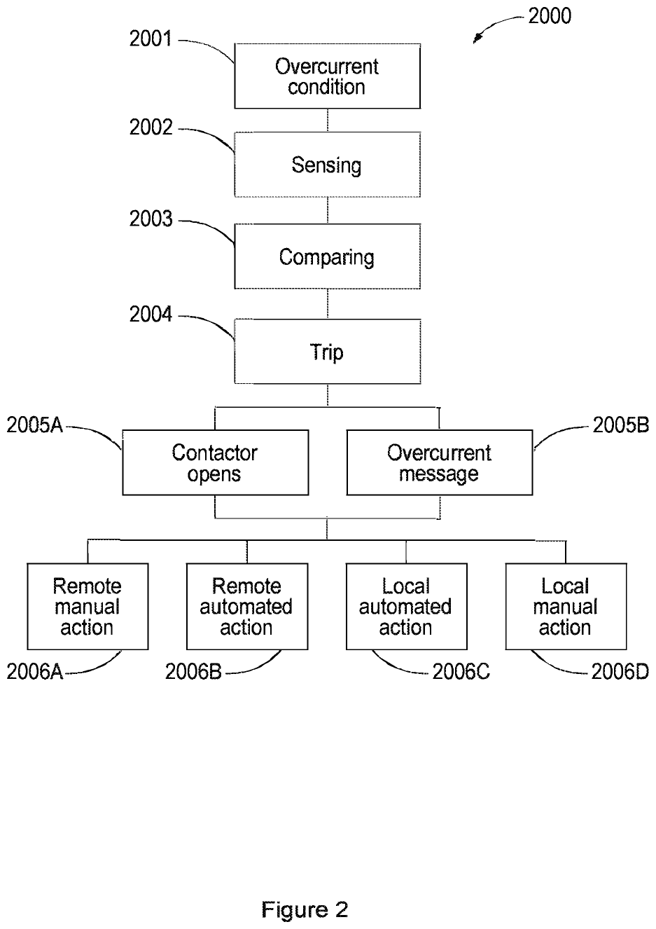

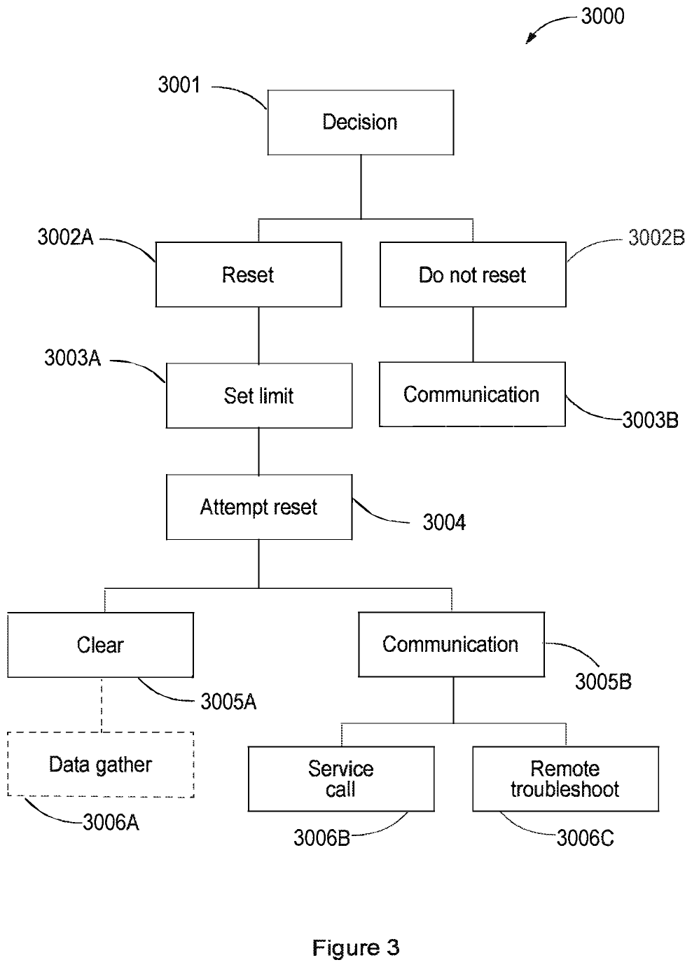

Assuming the electrical system illustrated in FIGS. 1A and B, in combination with the conventional GFCI functionality, the remote power control means of U.S. Pat. No. 6,681,110, and ground monitoring means of U.S. Pat. No. 8,537,516, there are a number of different methods which could be set forth to provide both onsite and offsite responses to a trip condition from a remote location; FIGS. 2 and 3 illustrate one possible method and sub-method, respectively.

According to method 2000, a first step 2001 comprises defining an overcurrent condition—specifically, with respect to leakage current. In practice an overcurrent condition could be actual (e.g., leakage current measures 20 mA and the circuit trips because 20 mA is a regulatory-defined threshold); however, an overcurrent condition could also be impeding (e.g., historical data shows a steady rise in leakage current and it is assumed some sort of degradation is occurring which might impact power wiring and cause an unsafe leakage current). It is even possible according to aspects of the present disclosure for an overcurrent condition to be merely perceived; for example, depending on the characteristics of the load or even soil conditions, persons may set an overcurrent threshold above 20 mA (e.g., 30 mA) or below 20 mA (e.g., 15 mA) because it is believed nuisance tripping (see again U.S. Pat. No. 8,320,089) would otherwise occur.

Irrespective of the impetus, one or more overcurrent conditions are set in accordance with step 2001 such that sensing of leakage current 2002 (e.g., using means and methods in U.S. Pat. No. 8,320,089) results in a comparison between measurement and threshold(s) (step 2003), so that if a defined outcome results, a trip will occur and interrupt power in the impacted circuit (step 2004). In practice, one or more overcurrent conditions defined according to step 2001 would be effectively stored in the electrical system as either a defined limit in the hardware (e.g., a model LM311 comparator available from Texas Instruments Incorporated, Dallas, Tex., USA) or as an adjustable limit in the software (e.g., according to UL-1998)—such as a model MKV56F512VLL24 microprocessor available from NXP Semiconductors Netherlands B.V., Eindhoven, Netherlands).

Once a trip condition occurs at step 2004, two things happen in conjunction: a contactor of the conventional GFCI functionality (see contactor module 43, FIG. 1B) opens thereby interrupting power flow to the impacted circuit (step 2005A), and an overcurrent message is sent back to remote control center 1000 at step 2005B (as envisioned, via existing RS-485 communication wiring to control module 42 and onward via antenna 41). It is at this point that one or more of a number of things may occur in response to the trip and communicated message to remote control center 1000—see steps 2006A-D.

A remote manual action 2006A may take place; an example of this may be to dispatch service persons to troubleshoot and/or repair the electrical system. The action is remote insomuch as the decision originates from remote control center 1000 (see again U.S. Pat. No. 6,681,110), but the decision is manual insomuch that persons rather than automated processes are involved in the resolution. In practice, persons at remote control center 1000 would likely see a display appear on a monitor indicating the site location, status of the system (e.g., tripped), and additional information (e.g., historical leakage current measurement, trendline of leakage current over some period, number of circuits, number of loads on a circuit, etc.)—what will be referred to as a “control screen”. This information will likely provide input to persons at remote control center 1000 in determining which of steps 2006A-D is most appropriate, and any of the aforementioned information which would likely appear on the control screen at remote control center 1000 could also appear on site on a screen 403 (FIG. 4, later discussed). Of course, the same result could occur by a remote automated action 2006B instead; for example, service persons may automatically be dispatched to the site if it is known there are service persons within 100 miles of the site.

However, a remote automated action 2006B could be more complex, involve additional steps, or otherwise be in addition to step 2006A; see sub-method 3000 (FIG. 3). At the core of sub-method step 3001 is a decision (local or remote, manual or automated); this decision can be the result of preferences defined by persons (e.g., frequency and mode of reporting), regulations or guidelines (e.g., UL-943, UL-943C), the site itself (e.g., mode of visual indication), or the electrical system itself (e.g., access to enclosures), for example. Consider first a decision to not attempt any remote action to reset the trip (step 3002B)—perhaps the trip was anticipated because of local construction, or the site is not safe for dispatching persons. In this case the trip condition, events leading to the trip, or other information may merely be reported out to persons in a predetermined fashion according to step 3003B; U.S. Pat. No. 8,605,394 incorporated by reference herein in its entirety discusses how a remotely located control center may monitor leakage current and report out according to one or more predetermined factors when an overcurrent condition occurs—as opposed to taking action.

It may be desirable to attempt to reset the GFCIs and clear the trip (step 3002A) remotely (e.g., via selection of a button or option on the aforementioned control screen). In practice, selecting such an option on the control screen would communicate a command from remote control center 1000, to antenna 41, via RS-485 to control module 42, and to contactor module 43 of the tripped circuit—and functionally would be similar to a normal “on” command from the remote power control means (see again U.S. Pat. No. 6,681,110) except the command is only sent to the impacted circuit rather than all the circuits of the system. Of course, there would likely be a limit to the number of times to try and clear the trip remotely (e.g., to limit noise onsite from contactors attempting to engage). Step 3003A could be preset by persons using the system, persons at remote control center 1000, or otherwise, and while illustrated as occurring after the decision to reset the circuit (step 3002A), could occur at commissioning of the system and prior to any trip, for example.

Regardless of when a limit is set, the limit is in effect when attempting to remotely clear the trip by reengaging the contactors as previously described herein (step 3004). It is possible after some number of attempts the trip will clear (step 3005A); this could be because of a line power surge, or water filling underground wiring conduit during heavy rains, or other factor that only temporarily resulted in leakage current measurements above the threshold(s). It may be desirable in such an event to attempt to gather information that led to the overcurrent condition (optional step 3006A); for example, tracking weather patterns with respect to when the trip occurred. However, it is also possible that the trip will not clear before hitting the limit of tries; in this case some kind of communication occurs (step 3005B). This could be an internal communication—namely, within remote control center 1000 to indicate an automated reset process failed and troubleshooting efforts must be escalated—which might result in dispatching services persons (step 3006B) or performing remote troubleshooting (step 3006C). Electrical systems such as that illustrated in FIGS. 1A and B which are enabled with remote power control functionality such as that in U.S. Pat. No. 6,681,110 often have a status feedback signal (e.g., to ensure contactors close and lights turn on as desired) which provides feedback back to remote control center 1000, and this signal can be used remotely to provide some level of troubleshooting (e.g., to narrow down which circuit or set of circuits is impacted). As another example, the communication could be external—for example, to persons associated with the electrical system to inform them the automated reset process has failed and inquire as to next steps; this form of communication might be similar in form and approach to communication step 3003B.

It can be seen that selecting one or more of steps 2006A-D may be a relatively simple process, or may involve one or more sub-methods such as that illustrated in FIG. 3. It can also be seen that steps 2006A-D can be combined. For example, as discussed some degree of remote troubleshooting might be performed according to step 3006C; this initial information could be combined with a local manual action 2006D of persons on site using the remotely obtained information to narrow the search for the trip and thereby aid in local troubleshooting. In this sense, there is still a reduction in time and effort spent to clear a trip, and so still a benefit to be had.

In some examples, even more can be done to reduce time and effort spent attempting to clear a trip in large, complex, and/or high voltage electrical systems already enabled with GFCI-type functionality; namely, by including a local automated action (step 2006C). For instance, a local automated action may comprise automatic activation of a visual alert system on site at or near the electrical system; see FIG. 4. As can be seen, a large/long range visual device 404 is mounted on control enclosure 40 which, upon a trip, will automatically illuminate to enable persons to more readily locate an impacted circuit; this could be in addition to, or in lieu of, a small/short range visual device 402. In this example visual indicators 402/404 operate on the same line power/power source as control module 42 so that power is not removed from the indicators when a trip occurs. A screen 403 could display information relating to the trip and impacted circuit, or could include additional information gathered remotely (see again step 3006A). It is even possible that by accessing enclosure 40 by unlatching lock 406 and opening door 405 a series of prompts might be initiated on screen 403 for onsite troubleshooting. Of course, screen 403 could be omitted entirely and any information communicated through a series of flashing patterns of visual indicators 402/404; all of the aforementioned are possible, and envisioned.

The invention may take any number of forms. The foregoing examples are but a few of those. To give some sense of some options and alternatives, a few examples are given below.

Discussed and illustrated herein are remote control options for GFCI-type functionality in large, complex, and/or high voltage electrical systems, as well as means and methods to implement varying degrees of responses to a trip depending on whether an overcurrent condition is impeding, actual, or perceived. It can be noted that from a general standpoint a number of features may differ from those described and illustrated herein, and not depart from at least some aspects according to the techniques and systems described herein. For example, a load may not include a lighting fixture or light source, and the electrical system may not be a sports lighting system or other geographically spread-out electrical system. As another example, GFCI functionality may not be pre-existing, and may be installed (in accordance with U.S. Pat. No. 8,320,089, for example) at the same time as visual indicators. As another example, while there is a benefit to having remote power control for electrical systems such as those described herein, it need not be pre-existing, nor as advanced as that described in U.S. Pat. No. 6,681,110. Such functionality may be installed (in accordance with U.S. Pat. No. 6,681,110 or otherwise) at the same time as establishing reporting mechanisms and communication procedures, for example. As yet another example, an electrical system may not have an onsite reset button or similar device—or it may be disabled—and attempts to clear a trip may only be attempted remotely.

With respect to method 2000 and sub-method 3000 it can be appreciated that these may include more, different, or fewer steps than those illustrated herein—as well as include different examples of action taken. For example, step 2006D need not include any level of troubleshooting as a local manual action—perhaps it only includes locating enclosure 40, accessing enclosure 40, and pushing a reset button by local persons (e.g., owner of the electrical system) using information gathered from remote control center 1000. In this sense there is still value added in the method because persons may be notified (well ahead of a scheduled game) that a trip has occurred, and therefore inconvenience is reduced. As another example, external communication (e.g., in the form of a report to persons using the electrical system, see again U.S. Pat. No. 8,605,394) or internal communication (e.g., that the baseline leakage current has been reset for new trending in response to optional step 3006A) could occur multiple times at multiple points in method 2000/sub-method 3000 in accordance with preferences. As yet another example, one or more thresholds which form the basis of steps 2001-2004 need not be defined in accordance with regulation (e.g., UL-943C) to benefit from subsequent steps 2006A-D; person-defined preferences could drive the entire methodology.

Additionally, with respect to onsite visual indicators which allow persons to more readily locate a trip, it should be noted these could differ from the means and methods described and illustrated herein, and not depart from at least some aspects of the techniques and systems described herein. A simple example is visual indicators 402/404 could operate off of battery power—thereby not only providing visual indication of a trip, but also a visual indication of how long ago it occurred (e.g., if visual indicators include LEDs, they will dim as battery power is depleted). As another example, a visual indicator 402/404 might be located at each enclosure 50 in the electrical system and operate on the same power as load 300. In this example, visual indicators 402/404 would always be illuminated until a trip occurred, and then would go dark—this would also provide a visual indication as intended, and with the benefit of more precisely locating the impacted circuit(s). In this sense, even though the actual reset button is likely located in enclosure 40 and away from the visual indicator(s), the visual cue of having the indicators go dark at the poles with lighting fixtures allows onsite persons to determine if one field of play is impacted, if two are, etc.—and in a rapid fashion. All of the aforementioned are possible, and envisioned.

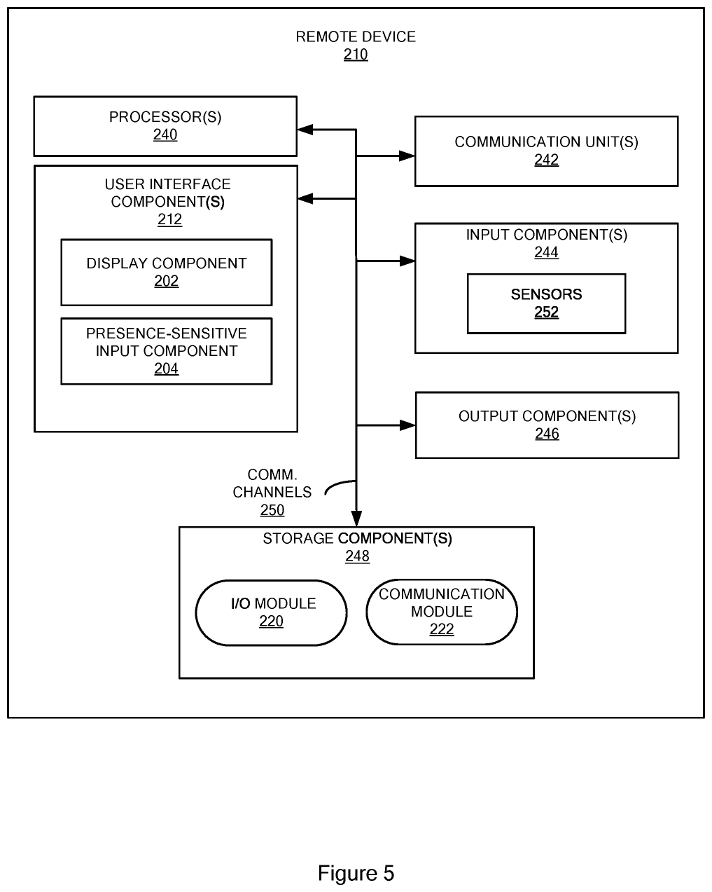

FIG. 5 is a block diagram illustrating a more detailed example of a computing device configured to perform the techniques described herein. Remote device 210 of FIG. 5 is described below as an example of a computing device at, for example, control center 1000, that is configured to communicate with control enclosures 40, in accordance with the techniques and systems described above.

Remote device 210 may be any computer with the processing power required to adequately execute the techniques described herein. For instance, remote device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 5, remote device 210 includes one or more user interface component(s) (UIC) 212, one or more processors 240, one or more communication units 242, one or more input components 244, one or more output components 246, and one or more storage components 248. UIC 212 includes display component 202 and presence-sensitive input component 204. Storage components 248 of remote device 210 include I/O module 220 and communication module 222.

One or more processors 240 may implement functionality and/or execute instructions associated with remote device 210 to receive signals from electrical systems with GFCIs and output responsive actions back to a command module of the electrical systems with GFCIs. That is, processors 240 may implement functionality and/or execute instructions associated with remote device 210 to analyze signals indicative of leakage current in an electrical system and attempt to resolve the trip caused by the potential leakage current remotely.

Examples of processors 240 include application processors, display controllers, auxiliary processors, one or more sensor hubs, and any other hardware configured to function as a processor, a processing unit, or a processing device. Modules 220 and 222 may be operable by processors 240 to perform various actions, operations, or functions of remote device 210. For example, processors 240 of remote device 210 may retrieve and execute instructions stored by storage components 248 that cause processors 240 to perform the operations described with respect to modules 220 and 222. The instructions, when executed by processors 240, may cause remote device 210 to receive signals from electrical systems with GFCIs and output responsive actions back to a command module of the electrical systems with GFCIs.

I/O module 220 may execute locally (e.g., at processors 240) to provide functions associated with analyzing received signals, outputting elements on a display, and/or control the actions communicated back to the electrical system. In some examples, I/O module 220 may act as an interface to a remote service accessible to remote device 210. For example, I/O module 220 may be an interface or application programming interface (API) to a remote server that develops response actions based on an analysis I/O module 220 performs on a received signal.

In some examples, communication module 222 may execute locally (e.g., at processors 240) to provide functions associated with receiving and outputting various signals using communication units 242. In some examples, communication module 222 may act as an interface to a remote service accessible to remote device 210. For example, communication module 222 may be an interface or application programming interface (API) to a remote server that receives signals from electrical systems and outputs.

One or more storage components 248 within remote device 210 may store information for processing during operation of remote device 210 (e.g., remote device 210 may store data accessed by modules 220 and 222 during execution at remote device 210). In some examples, storage component 248 is a temporary memory, meaning that a primary purpose of storage component 248 is not long-term storage. Storage components 248 on remote device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222. Storage components 248 may include a memory configured to store data or other information associated with modules 220 and 222.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of remote device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of remote device 210 may receive input. Examples of input are tactile, audio, and video input. Input components 244 of remote device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of remote device 210 may generate output in a selected modality. Examples of modalities may include a tactile notification, audible notification, visual notification, machine generated voice notification, or other modalities. Output components 246 of remote device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

Output components 246 may also be external to remote device 210. For instance, communication module 222 may generate a signal that includes various output information and transmit the signal, using communication units 242, to enclosure 40, which may output, for visualization, the output information on one or more of visual device 402, screen 403, and visual indicator 404. In other words, output components 246 may also include visual device 402, screen 403, and visual indicator 404, external to remote device 210.

UIC 212 of remote device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of remote device 210, UIC 212 may also represent an external component that shares a data path with remote device 210 for transmitting and/or receiving input and output. For instance, in one example, UIC 212 represents a built-in component of remote device 210 located within and physically connected to the external packaging of remote device 210 (e.g., a screen on a mobile phone). In another example, UIC 212 represents an external component of remote device 210 located outside and physically separated from the packaging or housing of remote device 210 (e.g., a monitor, a projector, etc. that shares a wired and/or wireless data path with remote device 210).

UIC 212 of remote device 210 may detect two-dimensional and/or three-dimensional gestures as input from a user of remote device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with one or more techniques described herein, communication module 222 may control one or more communication units to receive, from an electrical system, a signal indicating activation of a GFCI. In some instances, the activation of the GFCI includes an indication of the GFCI terminating power to at least a portion of the electrical system in response to an overcurrent condition. For example, the overcurrent condition may include any one or more of a perceived leakage current condition, an actual leakage current condition, and an impending leakage current condition.

In response to communication module 222 and communication units 242 receiving the signal including the activation of the GFCI, I/O module 220 may generate a response signal including instructions for performing one or more of a remote manual action, a remote automated action, a local automated action, and a local manual action. In some instances, the remote automated action may be I/O module 220 attempting to reset the GFCI from the remote control center by providing power to at least the portion of the electrical system. In some such instances, in providing the power from the remote control center, communication module 222 and communication units 242 may, at least partially, wirelessly communicate a power control command to a control module of the electrical system.

In some instances, the local automated action may include activating a visual alert system at or near the electrical system. For instance, communication module 222 may send a signal to one or more of visual device 402, screen 403, and visual indicator 404 at enclosure 40, which would thereby display the alert.

Communication module 222 and communication units 242 may further send the response signal to the electrical system. In some instances, communication module 222 and communication units 242 may further receive, from the electrical system, one or more feedback signals. In some such instances, I/O module 220 may output, for display via one or more output components 246 or display component 202, one or more of said feedback signals, availability of service persons, and options for responses to the overcurrent condition.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage components, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method of remotely resetting a GFCI in an electrical system comprising:
upon detection of a predetermined leakage current, activating the GFCI;
communicating a signal indicating activation of the GFCI to a remote control center; and
according to one or more predetermined factors, performing one or more of the following:
a remote manual action;
a remote automated action;
a local automated action; and
a local manual action.

2. The method of claim 1, wherein activating the GFCI comprises removing power to at least a portion of the electrical system.

3. The method of claim 2, wherein the remote manual action comprises:
assessing, by the remote control center, availability of service persons; and
dispatching service persons to troubleshoot and/or repair the electrical system.

4. The method of claim 2, wherein the remote automated action comprises attempting to reset the GFCI from the remote control center by providing power to at least the portion of the electrical system.

5. The method of claim 4, wherein the providing of power from the remote control center comprises at least partially wirelessly communicating a power control command to a control module of the electrical system.

6. The method of claim 2, wherein the local automated action comprises automatically activating a visual alert system at or near the electrical system.

7. The method of claim 2, wherein the local manual action comprises:
assessing, by the remote control center, (i) a general location of the GFCI activation and (ii) the portion of the electrical system with removed power; and
communicating (i) and (ii) to one or more local persons as determined by the one or more predetermined factors.

8. A system for remote monitoring, trending, reporting, and/or response of an overcurrent condition comprising:
an electrical system;
a GFCI associated with the electrical system adapted to terminate power to at least a portion of the electrical system in response to the overcurrent condition;
a remote control center;
a control module associated with the electrical system adapted to communicate one or more power commands from the remote control center to the electrical system, and further adapted to communicate one or more feedback signals to the remote control center; and
a display associated with the remote control center which displays one or more of:
said feedback signals;
availability of service persons; and
options for responses to the overcurrent condition.

9. The system of claim 8, wherein the options for responses are persons-defined.

10. The system of claim 9, wherein the persons-defined options are defined prior to installation of the electrical system.

11. The system of claim 8, wherein the overcurrent condition comprises one or more of:
a perceived leakage current condition;
an actual leakage current condition; and
an impending leakage current condition.

12. The system of claim 8, further comprising ground monitoring means, and wherein the display further displays information associated with the ground monitoring means.

13. A device for remotely resetting a GFCI in an electrical system, the device comprising:
one or more communication units configured to:
receive, from the electrical system, a signal indicating activation of the GFCI; and
one or more processors configured to:
in response to receiving the signal including the activation of the GFCI, generate a response signal including instructions for performing one or more of:
a remote manual action;
a remote automated action;
a local automated action; and
a local manual action
wherein the one or more communication units are further configured to send the response signal to the electrical system.

14. The device of claim 13, wherein the one or more communication units are further configured to receive, from the electrical system, one or more feedback signals.

15. The device of claim 14, further comprising:
a display device,
wherein the one or more processors are further configured to output, for display via the display device, one or more of:
said feedback signals;
availability of service persons; and
options for responses to the overcurrent condition.

16. The device of claim 13, wherein the activation of the GFCI comprises an indication of the GFCI terminating power to at least a portion of the electrical system in response to an overcurrent condition.

17. The device of claim 16, wherein the overcurrent condition comprises one or more of:
a perceived leakage current condition;
an actual leakage current condition; and
an impending leakage current condition.

18. The device of claim 16, wherein the remote automated action comprises attempting to reset the GFCI from the device by providing power to at least the portion of the electrical system.

19. The device of claim 18, wherein the one or more processors are configured to provide the power from the device by at least partially wirelessly communicating, using the one or more communication units, a power control command to a control module of the electrical system.

20. The device of claim 16, wherein the local automated action comprises the one or more processors automatically activating a visual alert system at or near the electrical system.
